(19) United States
(12) Patent Application Publication
(10) Pub. No.: US 2012/0007815 A1
(43) Pub. Date: Jan. 12, 2012

(54) MULTIPURPOSE SENSING APPARATUS AND ELECTRONIC EQUIPMENT HAVING THE SAME

(75) Inventors: Woon-bae KIM, Seoul (KR); Min-Seog CHOI, Seoul (KR); Eun-Sung LEE, Hwaseong-si (KR); Kyu-Dong JUNG, Suwon-si (KR)

(73) Assignee: SAMSUNG ELECTRONICS CO., LTD., Suwon-si (KR)

(21) Appl. No.: 13/035,317

(22) Filed: Feb. 25, 2011

(30) Foreign Application Priority Data
Jul. 9, 2010 (KR) 10-2010-0066606

(51) Int. Cl. G06F 3/041

(52) U.S. Cl. 345/173

(57) ABSTRACT

A multipurpose sensing apparatus and electronic equipment are provided. The sensing apparatus includes planar type compound eyes, each planar type compound eye including ommatidium arranged in a circular arc such that each ommatidium views a contact surface; three-dimensional (3D) compound eyes, each 3D compound eye including ommatidium arranged in an array such that each ommatidium views an area in front of the contact surface; and an image signal processor that is configured to determine a touch position on the contact surface based on image signals transmitted from the planar type compound eyes, and to recognize a motion of an object existing in front of the contact surface based on image signals transmitted from the 3D compound eyes.

### CROSS-REFERENCE TO RELATED APPLICATION

This application claims priority under 35 U.S.C. §119(a) from Korean Patent Application No. 10-2010-0066606, filed on Jul. 9, 2010, the disclosure of which is incorporated by reference in its entirety for all purposes.

### BACKGROUND

1. Field

The following description relates to a sensing apparatus for electronic equipment.

2. Description of the Related Art

A sensing apparatus may be classified depending on an object to be sensed. For example, a motion sensing apparatus senses whether a motion occurs or recognizes a traveling distance, speed, traveling path or trace of a moving object. On the other hand, a touch sensing apparatus such as a touch panel can recognize touching itself and also a position of touching, or a multi-touch. Such a motion sensing apparatus and touch sensing apparatus are used in a user interface for electronic equipment.

One example of the motion sensing apparatus applied to electronic equipment as a user interface is in a game console, for example, Wii® released by Nintendo®. The game console senses the motion of a user as the user moves while holding a secondary device, in which the secondary device is equipped with a plurality of sensors such as an inertial sensor or a gyro sensor. Other examples of the motion sensing apparatus use a motion capturing recognition method, in which the upper/lower motion and left/right motion of a user is collectively recognized using a three-dimensional (3D) camera or the motion of a user is recognized using an infrared ray (IR) projector and an IR detector.

One example of the touch sensing apparatus applied to electronic equipment as a user interface is a touch screen of a mobile device. In addition, the touch screen is widely used in many applications including, for example, large scaled electronic equipment, an automated teller machine, a ticket vending machine and electronic devices for tourism guiding or traffic guiding. Touch screens are classified into capacitive type touch screens, resistive film type touch screens, surface acoustic wave (SAW) type touch screens and infrared type touch screens depending on the sensing method. In recent years, a touch screen capable of sensing a multi-touch has become increasingly diversified, for example, a smart phone and a tablet computer.

As described above, the motion sensing apparatus of domestic electric appliances and the touch sensing apparatus of a mobile device have found wide applicability in user interfaces. However, such a user interface of the electronic equipment has a limit in supporting both motion sensing and touch sensing simultaneously. In particular, the motion sensing apparatus requires a secondary device equipped with an inertial sensor and a gyro sensor or requires a large scale camera.

### SUMMARY

One or more exemplary embodiments provide a multipurpose sensing apparatus capable of supporting motion sensing and multi-touch sensing and electronic equipment having the same.

One or more exemplary embodiments also provide a multipurpose sensing apparatus having a small size and thin thickness and electronic equipment having the same.

According to a an aspect of an embodiment, there is provided a multipurpose sensing apparatus including a plurality of planar type compound eyes, each planar type compound eye comprising a plurality of ommatidium arranged in a circular arc such that each ommatidium views a contact surface; a plurality of three-dimensional (3D) compound eyes, each 3D compound eye comprising a plurality of ommatidium arranged in an array such that each ommatidium views an area in front of the contact surface; and an image signal processing unit that is configured to determine a touch position on the contact surface based on image signals transmitted from the plurality of planar type compound eyes, and to recognize a motion of an object existing in front of the contact surface based on image signals transmitted from the plurality of 3D compound eyes.

According to an aspect of another embodiment, there is provided electronic equipment including a housing comprising at least one display surface; a plurality of planar type compound eyes, each planar type compound eye comprising a plurality of ommatidium arranged in a circular arc on the housing such that each ommatidium views the display surface; a plurality of three-dimensional (3D) compound eyes, each 3D compound eye comprising a plurality of ommatidium arranged in an array on the housing such that each ommatidium views an area in front of the display surface; and an image signal processing unit that is configured to determine a touch position on the display surface based on image signals transmitted from the plurality of planar type compound eyes, and to recognize a motion of an object existing in front of the display surface based on image signals transmitted from the plurality of 3D compound eyes; and an input determination unit that is configured to determine an input by use of at least one of the touch position and the motion of the object obtained by the image signal processing unit.

According to an aspect of another embodiment, there is provided a sensing apparatus for determining an input in electronic equipment having a housing including a contact surface, the sensing apparatus comprising a binocular compound eye provided on at least one side of the housing, wherein the sensing apparatus senses a touch on the contact surface and motion in front of the contact surface, based on the binocular compound eye.

According to an aspect of another embodiment, there is provided a multipurpose sensing apparatus including a plurality of planar type compound eyes that are configured to view a contact surface; a plurality of three-dimensional (3D) compound eyes that are configured to view an area in front of the contact surface; and an image signal processing unit that is configured to calculate a touch position on the contact surface based on image signals transmitted from the plurality of planar type compound eyes and to recognize a motion of an object existing in the front of the contact surface based on image signals transmitted from the plurality of 3D compound eyes

### BRIEF DESCRIPTION OF THE DRAWINGS

The above and/or other aspects will be more apparent from the following detailed description taken in reference to the attached drawings, in which:

FIG. 1 is a block diagram illustrating one example of electronic equipment having a multipurpose sensing apparatus according to an exemplary embodiment;

FIG. 2A is a perspective view illustrating an example of a structure of a planar type compound eye included in the multipurpose sensing apparatus shown in FIG. 1;

FIG. 2B is a perspective view illustrating an example of a structure of a 3D type compound eye included in the multipurpose sensing apparatus shown In FIG. 1;

FIG. 3 is a view illustrating an example of a structure of an ommatidium according to an exemplary embodiment;

FIG. 4 is a view illustrating an example of a process of calculating a touch point from two planar type compound eyes disposed at a middle a display screen;

FIG. 5 is a view illustrating an example of a structure of compound eyes applying a structure of a binocular telescope according to an exemplary embodiment;

FIG. 6A is a block diagram illustrating another example of electronic equipment having a multipurpose sensing apparatus according to an exemplary embodiment;

FIG. 6B is a view illustrating the structure of a planar type compound eye included in the multipurpose sensing apparatus shown in FIG. 6A;

FIG. 7 is a block diagram illustrating still another example of electronic equipment having a multipurpose sensing apparatus according to an exemplary embodiment; and

FIG. 8 is a view illustrating an example of a structure of a hemispherical compound eye according to an exemplary embodiment.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Elements, features, and structures are denoted by the same reference numerals throughout the drawings and the detailed description, and the size and proportions of some elements may be exaggerated in the drawings for clarity and convenience.

Hereinafter, examples will be described with reference to accompanying drawings in detail.

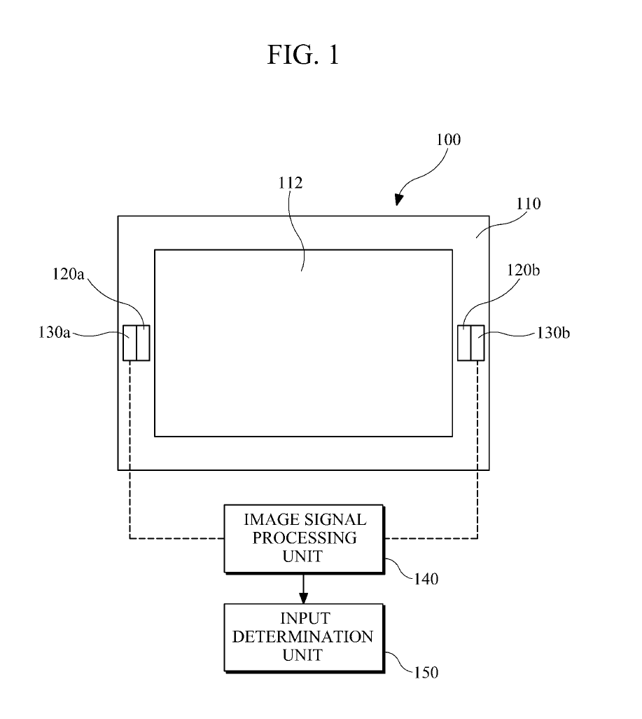

FIG. 1 is a block diagram illustrating one example of electronic equipment having a multipurpose sensing apparatus according to an exemplary embodiment. As shown in FIG. 1, electronic equipment 100 includes a housing 110, a plurality of planar type compound eyes 120 (reference numeral 120 may designate respective planar type compound eyes 120a and 120b), a plurality of 3D compound eyes 130 (reference numeral 130 may designate respective 3D compound eyes 130a and 130b), an image signal processing unit 140 and an input determination unit 150.

The housing 110 serves as a case of the electronic equipment 100, and may be equipped at an outside and/or an inside thereof with various components for operating the electronic equipment 100. The variety of components equipped in the housing 110 is not limited, and may depend on the type of the electronic equipment 100. In addition, the shape, size and material of the housing 110 are not limited, and the size of the housing 110 may vary depending on the type of the electronic equipment 110. For example, electronic equipment of the same type may have a housing of a different shape and electronic equipment of a different type may have a housing of the same shape.

The housing 110 may have at least one contact surface or a display surface 112. The contact surface represents an interfacing surface to be touched by a finger of a user, or by a secondary device, such as a stylus or the like, to input an instruction, information or data to the electronic equipment 100. The display surface represents an outer surface of a display panel formed on the electronic equipment 100 to provide a display image. The display surface also serves as the contact surface described above. In this case, the display surface always serves as the contact surface, but the converse is not true. That is, the contact surface need not always serve as the display surface. The contact surface or the display surface 112 (hereinafter, the contact surface and the display surface will be referred to as the display surface 112) may be attached to the outside of the housing 110 or inserted in a gap formed in the housing 110 to form an outer surface of the electronic equipment 100.

The electronic equipment 100 includes a plurality of planar type compound eyes 120. That is, the electronic equipment 100 includes at least two planar type compound eyes 120. FIG. 1 schematically shows only the position of the planar type compound eyes 120 in the form of a box, for the sake of convenience. In FIG. 1, the plurality of planar type compound eyes 120 include two planar compound eyes 120a and 120b that are disposed on edges of the display surface 112 facing each other. For example, in FIG. 1, the two planar compound eyes 120a and 120b are disposed at inner sides of the facing edges of the display surface 112, respectively. However, embodiments are not limited to such a disposition of the planar type compound eyes 120.

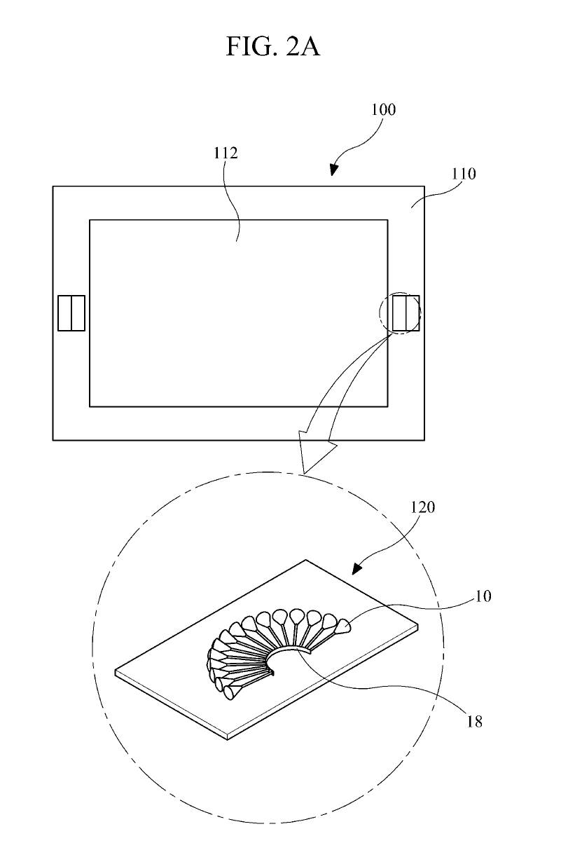

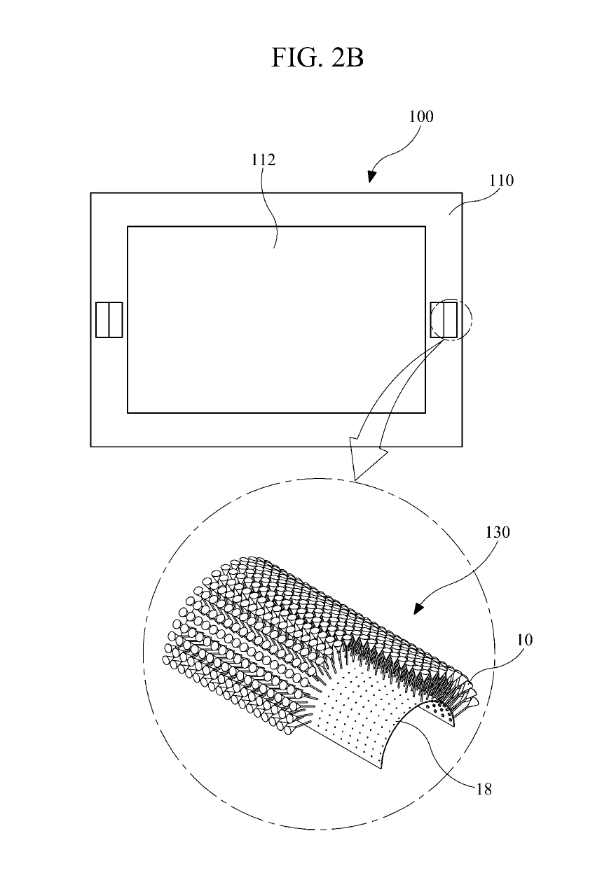

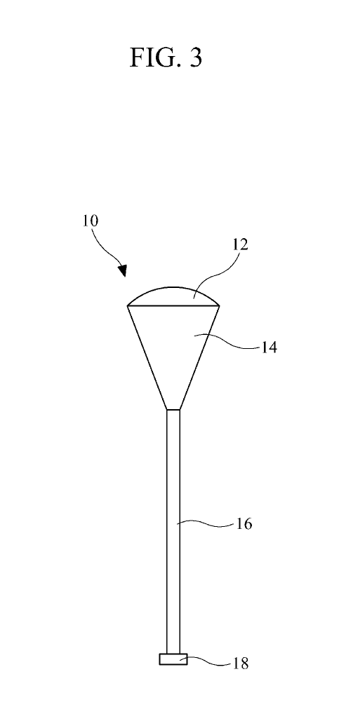

FIG. 2A illustrates an example of a structure of the planar type compound eye 120. As shown in FIG. 2A, the planar type compound eye 120 represents a compound eye including a plurality of ommatidium 10 that are disposed lying on the same plane. Details of the ommatidium 10 will be described later with reference to FIG. 3. For the sake of convenience, the planar compound eye 120 is illustrated as having about ten ommatidia, but the number of ommatidia included in one planar compound eye is not limited and may exceed several tens or several hundreds (see, e.g., FIG. 2B). In addition, the ommatidia 10 are disposed on the same plane parallel to the display surface 112, but the arrangement of the ommatidia 10 is not limited thereto.

Each of the ommatidia 10 forming the planar type compound eyes 120 views a single plane, for example, a portion of the display surface 112. The area viewed by one ommatidium 10 of the plurality of ommatidium 10 represents an area of the display surface 112 to which a lens 12 (see FIG. 3) of the ommatidium is directed. The area viewed by the planar type compound eye 120 corresponding to a collection of the ommatidia 10 represents a total area of the areas viewed by the respective ommatidium 10. A single planar type compound eye 120 may view the whole area of the display surface 112. Alternatively, a signal planar type compound eye 120 may view a portion of the display surface 112, and in this case, the planar type compound eyes 120 provided in the electronic equipment 100 cover the whole area of the display surface 112, on the grounds that image signals acquired by the planar type compound eye 120 are used to recognize a touch on the display surface 112.

As shown in FIG. 1 and FIG. 2B, the electronic equipment 100 also includes a plurality of three dimensional (3D) compound eyes 130. That is, at least two 3D compound eyes 130. FIG. 1 schematically shows only the position of the 3D compound eyes 130 in the form of a box, for the sake of convenience. In FIG. 1, the plurality of 3D compound eyes 130 include two 3D compound eyes 130a and 130b that are disposed on edges of the display surface 112 facing each other, respectively. For example, the two 3D compound eyes 130a and 130b are disposed at outer sides of the facing edges of the display surface 112, respectively. However, such a disposition of the 3D compound eyes 130 is not limited thereto.

The planar type compound eyes 120 are provided in the same number as the 3D type compound eyes 130, and the 3D type compound eye 130 is matched with the planar type compound eye 120 in one to one correspondence while being disposed adjacent to each other. In this case, the planar type compound eye 120 and the 3D compound eye 130 may share a single image sensor as a photo-detector 18. That is, the photo-detector 18 of the planar type compound eye 120 forms a single body together with the photo-detector 18 of the 3D compound eye 130.

FIG. 2B is a view illustrating an exemplary of a structure of the 3D type compound eye 130. As shown in FIG. 2B, the 3D compound eye 130 comprises a plurality of ommatidium 10 (details of the ommatidia 10 will be described later with reference to FIG. 3) that are disposed in an array on an image sensor corresponding to a collection of photo-detectors 18. For the sake of convenience, the 3D compound eye 130 is illustrated to have about nineteen (19) ommatidia 10 and about twenty six (26) ommatidia 10 arranged at either side of crosswise and lengthwise, respectively, but the number of ommatidia included in one 3D compound eye is not limited and may exceed several tens or several hundreds.

Each of the ommatidia 10 forming the 3D compound eyes 130 views in a single direction, for example, the front of the display surface 112. The area viewed by one ommatidium 10 of the plurality of ommatidium 10 represents a front space of the display surface 112 to which a lens 12 (see FIG. 3) of the ommatidium 10 is directed. The area viewed by the 3D compound eye 130 corresponding to a collection of the ommatidia 10 represents a total space of front spaces respectively viewed by the respective ommatidia 10. A single 3D compound eye 130 may view the whole front space of the display surface 120. Alternatively, a signal 3D compound eye 130 may view a portion of the front space of the display surface 112. In this case, the plurality of 3D compound eyes 130 provided in the electronic equipment 100 cover the whole front space of the display surface 112 or a preset space, on the grounds that image signals acquired by the 3D compound eye 130 are used to recognize a motion at the front of the display surface 112.

FIG. 3 is a view illustrating an example of a structure of the ommatidium 10 forming the planar type compound eye 120 and the 3D compound eye 130. As shown in FIG. 3, the ommatidium 10 includes a micro optical lens 12, a cone structure 14, an optical waveguide 16 and a photo-detector 18. Light signals reflected from an object sequentially pass through the micro optical lens 12 and the cone structure 14, and are collected. The collected light signals are guided through the optical waveguide 16 and transferred to the photo-detector 18. The photo-detector 18 is a light receiving element and corresponds to a unit pixel forming an image sensor, such as a charge coupled device (CCD) or a complementary metal oxide semiconductor (CMOS image sensor), or corresponds to a predetermined size (M×M) pixel.

In FIG. 2A, the collection of the photo-detectors 18 of the plurality of ommatidium 10 forming the planar type compound eye 120 are provided in the form of a band. For example, the band may be implemented in a planar shape or a curvilinear shape. The variation of the band shape represents that the collection of the photo-detectors 18 forming the planar type compound eye 120 may correspond to a single pixel column forming an image sensor of a predetermined size, or may correspond to a plurality of pixel columns forming an image sensor of a predetermined size. In particular, when the planar type compound eye 120 and the 3D compound eye 130 are disposed adjacent to each other while being matched with each other, the pixel column of the planar type compound eye 120 forms a signal body together with a curvilinear image sensor forming the 3D compound eye 130. For example, several outermost pixel arrays of one side of a curvilinear image sensor may be used as the photo-detectors 18 forming the planar type compound eye 120 and the rest of the curvilinear image sensor may be used as the photo-detectors 18 forming the 3D compound eye 130.

As another example, the planar type compound eye 120 may form a signal body together with the 3D compound eye 130. That is, for a compound eye forming a single structure, some ommatidia of the compound eye may be disposed to view the display surface 112 and used for the planar compound eye 120 and remaining ommatidia may be disposed to view the front of the display surface 112 and used for the 3D compound eye 130.

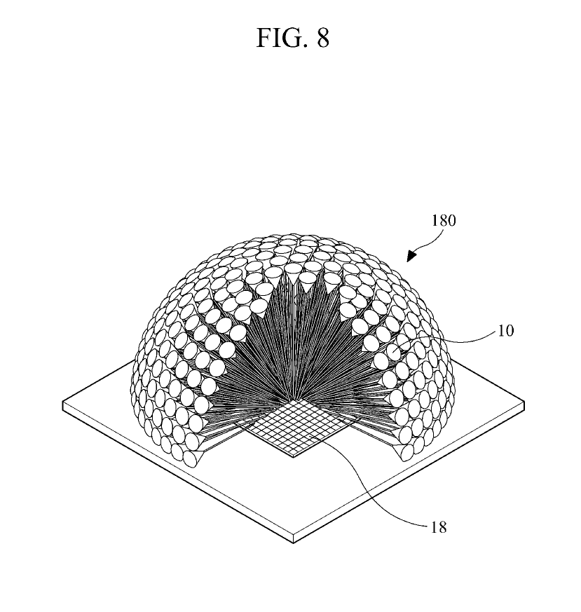

An integrated type compound eye 180 having the above structure is shown in FIG. 8. As shown in FIG. 8, the integrated type compound eye 180 includes a plurality of ommatidia, each having a micro optical lens 12 and a photo-detector 18, disposed in a hemispherical array. Ommatidia disposed parallel to the display surface 112, for example, first to third arrays of ommatidia disposed at the outermost arrays of the hemispherical array in a circle, may be used for the planar type compound eye 120, and the remaining ommatidia, for example, ommatidia disposed in the middle part of the hemispherical array, may be used for the 3D compound eye 130. In this case, the image sensor corresponding to the collection of the photo-detectors 18 is formed as a single body. Alternatively, the compound eye formed in a hemispherical array shown in FIG. 8 may only serve as an exclusive 3D compound eye.

Referring again to FIGS. 1, 2A and 2B, the number and arrangement (semi-circular or quadrant arrangement) of the plurality of ommatidia 10 forming the planar type compound eye 120 may vary depending on the place where the planar type compound eyes 120 are disposed on the display surface 112, or depending on whether the planar type compound eyes 120 cover the whole area or a portion of the display surface 112. Similarly, the number and arrangement of the plurality of ommatidium 10 forming the 3D compound eye 130 may vary depending on the place where the 3D compound eyes 130 are disposed on the display surface 112, or depending on whether the 3D compound eyes 130 cover the whole front space or a portion of the whole front space of the display surface 112.

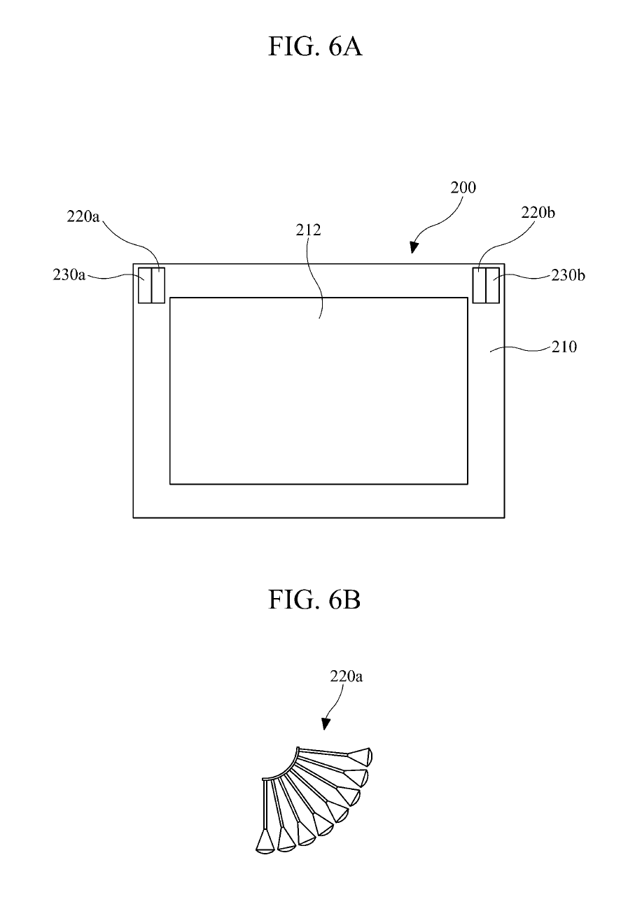

For example, it may be assumed that a pair of planar type compound eyes 120 are disposed at edges of the display surface 112. That is, the electronic equipment 100 includes two planar type compound eyes 120 disposed on edges of the housing 110 having the display surface 112. In this case, the two planar type compound eyes 120 may be disposed at two facing edges of the on the display surface 112, respectively. If the display surface 112 is provided in a rectangular shape having a widthwise side longer than a lengthwise side, the two planar type compound eyes 120 may be disposed at approximately the middle of either lengthwise side of the rectangle. Alternatively, the two planar type compound eyes 120 may be disposed at approximately the middle of either widthwise side of the rectangle, or disposed on respective corners of the rectangle (see, e.g., FIG. 6A).

When the two planar type compound eyes 120 are disposed at the middle of either lengthwise side of the display surface 112, the ommatidia 10 forming each of the planar type compound eyes 120a and 120b may be arranged in a semi-circular shape. The planar type compound eyes 120a and 120b including the ommatidia 10 disposed in a semi-circular shape view and cover the whole area of the display surface 112. In this case, the position of a touch point that is touched may be obtained through respective angles formed by the two planar type compound eyes 120a and 120b with respect to the touch point. The respective angles formed by the two planar type compound eyes 120a and 120b with respect to the touch point are obtained from angles formed by some ommatidia 10 receiving optical signals among the entire ommatidia 10 forming the planar type compound eyes 120a and 120b. However, the method of determining the respective angles is not limited thereto.

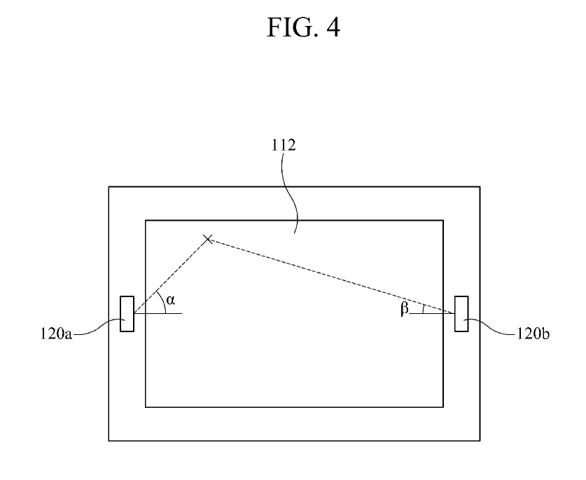

FIG. 4 is a view illustrating an example of a process of calculating a touch point from two planar type compound eyes each disposed at a middle level of the height of a display surface 112. The process of calculating the touch point is performed in the image signal processing unit 140 of the electronic equipment 100. As shown in FIG. 4, the angle formed by a left side planar type compound eye 120a with respect to the touch point is a, and the angle formed by a right side planar type compound eye 120b with respect to the touch point is β, and thus the touch point is determined as an intersection of two oblique lines extending with the angles α and β with respect to a parallel line.

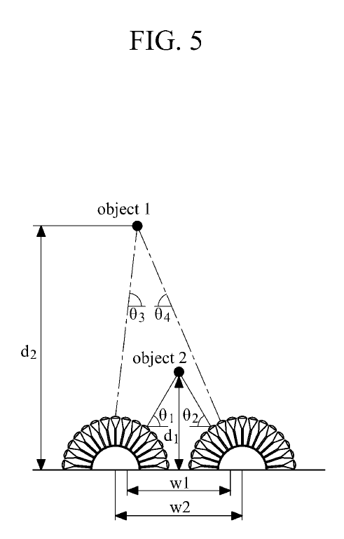

FIG. 5 is a view illustrating another example of a planar type compound eye or a 3D compound eye. Unlike the structure of the planar type compound eye 120 or the 3D compound eye 130 described above, in FIG. 5, each compound eye belonging to a planar type compound eye or a 3D compound eye is designed in a binocular system. FIG. 5 illustrates a process of measuring the position and the distance of object 1 and object 2 by use of the compound eyes designed as a binocular system. As shown in FIG. 5, a distance d1 of object 1 and a distance d2 of object 2 are obtained by use of distances w1, w2 between ommatidia receiving optical signals reflected from object 1 and object 2, respectively, and angles (θ1, θ2, θ3, θ4) of the ommatidia receiving the optical signals with respect to object 1 and object 2, respectively. That is, the compound eye designed as a binocular system may minimize a dead zone, and calculates image based distance and depth through triangulation, thereby providing benefits to sense the touch position and motion on, for example, a large scaled screen.

Alternatively, two planar type compound eyes may be disposed on corners of the display surface 112. FIG. 6A is a block diagram illustrating another example of electronic equipment 200. In FIG. 6A, an image signal processing unit and an input determination unit, which are the same as those of the previous example shown in FIG. 1, will be omitted in order to avoid redundancy. Similar to FIG. 1, the electronic equipment 200 shown in FIG. 6A includes a housing 210, a pair of planar type compound eyes 220a and 220b, and a pair of 3D compound eyes 230a and 230b. However, unlike FIG. 1, the electronic equipment 200 has the planar type compound eyes 220a and 220b and the 3D compound eyes 230 and 230b disposed at upper portions of edges of a display surface 212.

In this case, when the planar type compound eyes 220a and 220b are disposed at upper portions of edges of the display surface 212, the ommatidia 10 forming each of the planar type compound eyes 220a and 220b are provided in the form of a quadrant as shown in FIG. 6B. Each of the planar type compound eyes 220a and 220b including the ommatidia 10 disposed in the form of a quadrant views the entire display surface 212. In this case, the position of a touch point that is touched may be obtained through respective angles of the two planar type compound eyes 220a and 220b with respect to the touch point. The respective angles of the two planar type compound eyes 220a and 220b with respect to the touch point are obtained from angles formed by some ommatidia 10 receiving optical signals among the entire ommatidia 10 forming the planar type compound eyes 220a and 220b. However, the method of determining the respective angles is not limited thereto.

Referring again to FIGS. 1 and 2B, it may be assumed that a pair of the 3D type compound eyes 130 are disposed at edges of the display surface 112. That is, the electronic equipment 100 includes two 3D type compound eyes 130 disposed on edges of the housing 110 having the display surface 112. In this case, the two 3D type compound eyes 130 may be disposed at two facing edges of the display surface 112, respectively. If the display surface 112 is provided in a rectangular shape having a widthwise side longer than a lengthwise side, the two 3D compound eyes 130 may be disposed at the middle of either lengthwise side of the rectangle. Alternatively, the two 3D compound eyes 130 may be disposed at the middle of either widthwise side of the rectangle, or disposed on respective corners of the rectangle (see FIG. 6A).

When the two 3D compound eyes 130a and 130b are disposed at the middle of either lengthwise side of the display surface 112 or respective corners of the display surface 112, the ommatidia 10 forming each of the 3D compound eyes 130a and 130b may be disposed in a semi-cylindrical shape. The 3D compound eyes 130a and 130b including the ommatidia 10 disposed in a semi-cylindrical shape view and cover the front space and the side space of the display surface 112. In this case, the space range covered by the 3D compound eyes 130a and 130b may be controlled by adjusting the number or the arrangement of the ommatidia 10. In addition, the space range covered by the 3D compound eyes 130a and 130b may be controlled by varying parameters of optical components forming each ommatidium 10, that is, a micro optical lens, a cone structure and/or an optical waveguide. In this case, the motion is recognized by analyzing image signals received through the two 3D compound eyes 130a and 130b. The recognizing of the motion through image analysis may be performed in the image signal processing unit 140 of the electronic equipment 100.

When the two 3D compound eyes 130a and 130b are disposed at the middle of either lengthwise side of the display surface 112 or respective corners of the display surface 112, the ommatidia 10 forming each of the 3D compound eyes 130a and 130b may be disposed in a hemispherical shape (see FIG. 8). The 3D compound eyes 130a and 130b including the ommatidia 10 disposed in a hemispherical shape view and cover the front space, lower space, upper space and side space of the display surface 112. In this case, the space range covered by the 3D compound eyes 130a and 130b may be adjusted by the number or the arrangement of the ommatidia 10. In addition, the space range covered by the 3D compound eyes 130a and 130b may be adjusted by varying parameters of optical components forming each ommatidium 10, that is, a micro optical lens, a cone structure and/or an optical waveguide. In this case, the motion is recognized by analyzing image signals received through the two 3D compound eyes 130a and 130b.

As described above, the hemispherical compound eye shown in FIG. 8 may be used as an exclusive 3D compound eye or used as an integrated type compound eye. In further detail, image signals received from ommatidia, which are disposed at the outermost array of the hemispherical compound eye, that is, ommatidia disposed on the same plane, are used to calculate the occurrence of touch on the display surface. Image signals received from remaining ommatidia of the hemispherical compound eye may be used to recognize a motion. In this case, the ommatidia disposed at the outermost array of the hemi-spherical compound eye in a circle serve as a planar type compound eye in cooperation with one another.

The image signal processing unit 140 and the input determination unit 150 may be implemented by an electric circuit or software. In the drawings, each of the image signal processing unit 140 and the input determination unit 150 are illustrated as a separated block, but such a subdivision is based on a logical aspect. According to another example, the image signal processing unit 140 and the input determination unit 150 may be implemented into an integrated body.

The image signal processing unit 140 calculates the position of the touch point on the display surface 112 by use of the image signals transmitted from the planar type compound eyes 120a and 120b. As described above, the position of the touch point may be calculated by use of angles formed by radiation of the optical signals received through the planar type compound eyes 120a and 120b. The image signal processing unit 140 recognizes the motion existing at the front of the display surface 112 by use of the image signals transmitted from the 3D compound eyes 130a and 130b. The method of analyzing the image signals and recognizing the motion in the image signal processing unit 140 is not limited and may be achieved through any well-known method or algorithm.

The input determination unit 150 determines whether a touch input is made at a corresponding region, by use of the position of the touch point calculated by the image signal processing unit 140. The input determination unit 150 determines the type of motion made by use of the motion recognized by the image signal processing unit 140. Information about the type of motion may be previously stored in the electronic equipment 100, in which case the electronic equipment would include a storage. The input determination unit 150 transmits a notification signal indicating the occurrence of a type of motion to a controller of the electronic equipment 100, based on the calculated touch position and recognized motion. The controller, input determination unit 150 and/or the image signal processing unit 140 may be implemented using one or more central processing units (CPUs).

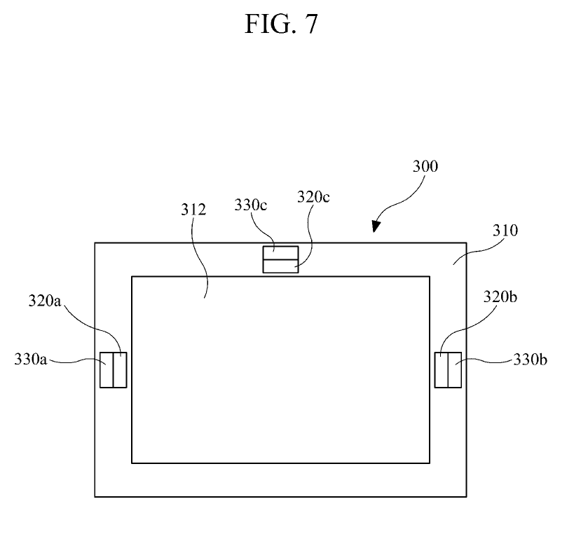

FIG. 7 is a block diagram illustrating still another example of electronic equipment 300. In FIG. 7, an image signal processing unit and an input determination unit, which are the same as those of the previous example shown in FIG. 1, will be omitted in order to avoid redundancy. As shown in FIG. 7, the electronic equipment 300 includes a housing 310, three planar type compound eyes 320a, 320b and 320c, and three 3D compound eyes 330a, 330b and 330c. Unlike FIG. 1, the electronic equipment 300 further includes the planar type compound eye 320c and the 3D compound eye 330c disposed at the middle position of an upper edge of a display surface 312. The planar type compound eye 320c views a touch point of the display surface and the 3D compound eye 330c views motion at the front of the display surface 312. Image signals obtained through the planar type compound eye 320c and the 3D compound eye 330c are used to calculate the touch point and recognize motion together with image signals obtained through the planar type compound eyes 320a and 320b and the 3D compound eyes 330a and 330b.

As described above, the multipurpose sensing apparatus senses a touch on a contact surface, and recognizes the motion at the front of the contact surface by use of a biomimetic compound eye. Accordingly, the multipurpose sensing apparatus simultaneously supports motion sensing and multi-touch sensing, and also ensures a small sized and thin thickness structure and economic efficiency.

Although exemplary embodiments have been described for illustrative purposes, those skilled in the art will appreciate that various modifications, additions and substitutions are possible, without departing from the scope and spirit of the inventive concept as disclosed in the accompanying claims.

What is claimed is:

1. A sensing apparatus comprising:
a plurality of planar type compound eyes, each planar type compound eye comprising a plurality of ommatidium arranged in a circular arc such that each ommatidium views a contact surface;
a plurality of three-dimensional (3D) compound eyes, each 3D compound eye comprising a plurality of ommatidium arranged in an array such that each ommatidium views an area in front of the contact surface; and
an image signal processing unit that is configured to determine a touch position on the contact surface based on image signals transmitted from the plurality of planar type compound eyes, and to recognize a motion of an object existing in front of the contact surface based on image signals transmitted from the plurality of 3D compound eyes.

2. The sensing apparatus of claim 1, wherein the plurality of planar type compound eyes comprises two planar type compound eyes that are disposed on edges of the contact surface facing each other, respectively.

3. The sensing apparatus of claim 2, wherein the circular arc is a semi-circle, and the planar type compound eyes are disposed at a middle of the edges of the contact surface, respectively.

4. The sensing apparatus of claim 2, wherein the circular arc is a quadrant and the planar type compound eyes are disposed at corners of the contact surface, respectively.

5. The sensing apparatus of claim 1, wherein the plurality of 3D compound eyes comprise two 3D compound eyes that are disposed on an outer part of the contact surface in symmetry with each other.

6. The sensing apparatus of claim 5, wherein each of the plurality of 3D compound eyes is provided in a semi-cylindrical shape or a hemispherical shape and disposed at a middle of edges of the contact surface.

7. The sensing apparatus of claim 1, wherein the plurality of planar type compound eyes are provided in a same number as the plurality of 3D type compound eyes, and the planar type compound eyes are matched with the 3D type compound eyes in a one-to-one correspondence, and each planar type compound eye and 3D type compound eye that are matched together are disposed adjacent to each other.

8. The sensing apparatus of claim 1, wherein each planar type compound eye comprises a photo-detector, and each 3D type compound eye comprises a photo-detector, and the photo-detector of the planar type compound eye forms a single body together with the photo-detector of the 3D type compound eye that is matched with the planar type compound eye in one-to-one correspondence.

9. The sensing apparatus of claim 7, wherein the planar type compound eye and the 3D type compound eye that are matched with each other in one-to-one correspondence form a hemispherical shape.

10. Electronic equipment comprising:
a housing comprising at least one display surface;
a plurality of planar type compound eyes, each planar type compound eye comprising a plurality of ommatidium arranged in a circular arc on the housing such that each ommatidium views the display surface;
a plurality of three-dimensional (3D) compound eyes, each 3D compound eye comprising a plurality of ommatidium arranged in an array on the housing such that each ommatidium views an area in front of the display surface; and
an image signal processing unit that is configured to determine a touch position on the display surface based on image signals transmitted from the plurality of planar type compound eyes, and to recognize a motion of an object existing in front of the display surface based on image signals transmitted from the plurality of 3D compound eyes; and
an input determination unit that is configured to determine an input by use of at least one of the touch position and the motion of the object obtained by the image signal processing unit.

11. The electronic equipment of claim 10, wherein the plurality of planar type compound eyes comprises two planar type compound eyes, which are disposed at facing positions, respectively, on an outer part of the display surface of the housing.

12. The electronic equipment of claim 11, wherein the circular arc is a semi-circle, and the planar type compound eyes are disposed at a middle of edges of the display surface.

13. The electronic equipment of claim 11, wherein the circular arc is a quadrant and the planar type compound eyes are disposed at corners of the display surface.

14. The electronic equipment of claim 10, wherein the plurality of 3D compound eyes comprises two 3D compound eyes that are disposed on an outer part of the display surface in symmetry with each other.

15. The electronic equipment of claim 14, wherein each of the plurality of 3D compound eyes is provided in a semi-cylindrical shape or a hemispherical shape and disposed at a middle of an edge of the display surface.

16. The electronic equipment of claim 10, wherein the plurality of planar type compound eyes are provided in a same number as the plurality of 3D type compound eyes, and the planar type compound eyes are matched with the 3D type compound eyes in one-to-one correspondence, and each planar type compound eye and 3D type compound eye that are matched together are disposed adjacent to each other.

17. The electronic equipment of claim 16, wherein each planar type compound eye comprises a photo-detector and each 3D type compound eye comprises a photo-detector, and the photo-detector of the planar type compound eye forms a single body together with the photo-detector of the 3D type compound eye that is matched with the planar type compound eye in one-to-one correspondence.

18. The electronic equipment of claim 16, wherein the planar type compound eye and the 3D type compound eye that are matched to each other in one-to-one correspondence form a hemispherical shape.

19. A sensing apparatus for determining an input in electronic equipment having a housing including a contact surface, the sensing apparatus comprising a binocular compound eye provided on at least one side of the housing, wherein the sensing apparatus senses a touch on the contact surface and motion in front of the contact surface, based on the binocular compound eye.

20. The sensing apparatus of claim 19, wherein the binocular compound eye comprises:
a plurality of planar type compound eyes, each of the planar compound eyes comprising a plurality of ommatidium arranged in a circular arc such that each ommatidium views the contact surface; and
a plurality of three-dimensional (3D) compound eyes, each of the 3D compound eyes comprising a plurality of ommatidium arranged in an array such that each ommatidium views an area in front of the contact surface.

21. A sensing apparatus comprising:
a plurality of planar type compound eyes that are configured to view a contact surface;
a plurality of three-dimensional (3D) compound eyes that are configured to view an area in front of the contact surface; and
an image signal processing unit that is configured to calculate a touch position on the contact surface based on image signals transmitted from the plurality of planar type compound eyes and to recognize a motion of an object existing in the front of the contact surface based on image signals transmitted from the plurality of 3D compound eyes.
